(19) United States
(12) Patent Application Publication
(10) Pub. No.: US 2006/0034026 A1
(43) Pub. Date: Feb. 16, 2006

(54) Electronic device

(75) Inventors: Hiroyuki Chiku, Kawasaki (JP); Shinji Kajihara, Kawasaki (JP); Yutaka Matsukuma, Kawasaki (JP); Kazuo Ueno, Kawasaki (JP); Akihiro Hamaguchi, Kawasaki (JP); Akira Kikuchi, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/002,193

(22) Filed: Dec. 3, 2004

(30) Foreign Application Priority Data
Aug. 13, 2004 (JP) 2004-235958

(51) Int. Cl. H02H 3/26

(52) U.S. Cl. 361/85

(57) ABSTRACT

An electronic device is composed of a reflector provided so as to cover a plug of a cabinet (sub-rack) into which a plug-in unit is plugged, and reflecting an electromagnetic wave which leaks from the plug; and a cable support supporting a cable connected to the plug-in unit and taken out of the plug, and forming an absorber which absorbs the electromagnetic wave reflected by the reflector.

### BACKGROUND OF THE INVENTION

1. Field of the Invention

The present invention relates to an electronic device, and in particular to an electronic device in which a plug-in unit (hereinafter, abbreviated as PIU) is plugged into a sub-rack.

In recent information communication devices or the like, systems have made rapid advancement in sophistication, speed-enhancement and downsizing. Together with such an advancement, integration of parts has been increased, so that it is predicted that an electromagnetic environment including a set-up environment of electronic devices used in the systems becomes more and more difficult to be attended. Under these circumstances, issues concerning reliability and safety for the electronic devices with an electromagnetic wave interference are coming to the fore, so that strict electromagnetic wave regulations are being instituted to the electronic device.

2. Description of the Related Art

As for product forms of recent electronic devices, a form called a rack-mount type has been often adopted. Since communication racks which used to be huge structures have become dramatically smaller in size, there is a possibility that the electronic devices are mounted on a sub-rack in a communication station.

Therefore, design consideration adaptable to any sub-rack is necessary in the above-mentioned product form of the electronic devices.

In the conventional technology, PIUs individually provided with a solid shielding structure have been used against an electromagnetic wave leakage. As shown in FIGS. 11A-11C, an individual PIU 72 plugged into a slot of a metallic cabinet (sub-rack) 71 possesses a solid shielding structure by having an electronic circuit board 73 covered with a metallic case 75 composed of a mounting portion 75a and a cover portion 75b, and by treating clearance processing thereto with a gasket (not shown) or the like.

Thus, the electromagnetic wave having leaked from each PIU 72 is prevented from influencing the PIU 72 mounted on an adjoining slot. Also, even if the metallic case 75 exists (especially when the metallic case 75 is compact and an electronic circuit is of a high-speed operation), the electromagnetic wave having leaked from the metallic case 75 reflects diffusely within the metallic cabinet 71, and the electromagnetic wave internally resonating generates a standing wave by a spatial operation of the metallic cabinet 71, so that electromagnetic wave interference is exerted on other PIUs.

A method of completely covering the electronic circuit board 73 of the PIU 72 with the metallic case 75 in order to counter the problem actually would result in a complicated shielding structure of a joint of a cable, a working joint of a metallic case or the like. Also, having the PIU 72 possess such a solid shielding structure would complicate insertion and extraction of the PIU 72 into/from a front or foreside of a plug, cooling of a heating electronic circuit, a maintenance of an inside of a device and the like. Therefore, it has been difficult to realize such a solid shielding structure.

Also, since the PIU 72 is inserted and extracted into/from the cabinet 71 in the electronic device of the prior art sub-rack structure, the electromagnetic wave leaks from the clearance between the PIUs 72 and an aperture of a cable connector, which leads to a problem of concentration of the electromagnetic wave emitted from the front of the cabinet 71.

If the emission of the electromagnetic wave to the front is tried to be suppressed in the individual PIU 72 in order to counter the problem, the structure of the PIU 72 is made complicated, which will be economically burdened.

Accordingly, against such a problem, a technology of suppressing the electromagnetic wave having leaked from the front of the cabinet 71, i.e. the plug of the PIU, to such a level at which electromagnetic interference to other PIUs is prevented even in the presence of an aperture of the cable connector is required.

Meanwhile, as a device for shielding an electromagnetic wave having leaked from a front of a cabinet, there is an electromagnetic wave absorber absorbing electromagnetic wave provided in front of the cabinet to be integrated, and comprising an integral structure of an inside electromagnetic wave absorbing layer and an outside electromagnetic wave reflecting layer, whereby the electromagnetic wave having leaked from the front of the cabinet is absorbed and the electromagnetic wave is reflected from the outside of the cabinet (see e.g. Patent Document 1).
[Patent document 1] Japanese Patent Application Laid-open No. 2001-119194

However, the electromagnetic wave absorber shown in the above patent document 1 is a visible light transmission radio wave absorber which transmits visible light whose inside can be observed from the outside without influencing an internal radio wave characteristic by a radio wave anechoic box. If such an electromagnetic wave absorber is provided in the above-mentioned cabinet front, an absorptance for the electromagnetic wave will be low, which leads to problems of having the electromagnetic wave leak to the outside and, in the presence of an aperture of a cable connector in the electromagnetic wave absorber, of having the electromagnetic wave leak from the aperture after the hit of the electromagnetic wave absorber from various angles.

### SUMMARY OF THE INVENTION

It is accordingly an object of the present invention to provide an electronic device which prevents electromagnetic wave having leaked from a plug of a PIU from interfering other PIUs.

In order to achieve the above-mentioned object, an electronic device according to the present invention comprises: a reflector provided so as to cover a plug of a sub-rack into which a plug-in unit is plugged, and reflecting an electromagnetic wave which leaks from the plug; and a cable support supporting a cable connected to the plug-in unit and taken out of the plug, and forming an absorber which absorbs the electromagnetic wave reflected by the reflector.

Namely, in the electronic device according to the present invention, electromagnetic wave having leaked from a plug of a PIU is reflected by a reflector and absorbed by an absorber which forms a cable support supporting a cable of the PIU. In this case, energy is gradually reduced by repeating the reflection, so that the electromagnetic wave is more easily absorbed by the absorber. Thus, it is possible to efficiently suppress the electromagnetic wave having leaked from the plug of the PIU, especially the aperture of the cable connector out of the PIU, thereby enabling electromagnetic wave interference to other PIUs to be eliminated.

Also, in the electronic device according to the present invention, the reflector may have a cover-like shape formed by a foreside face facing to the plug and three side faces between the plug and the foreside face, and the absorber may form a remaining side face.

Namely, in the electronic device, the electromagnetic wave having leaked from the plug of the PIU is reflected by the reflector formed by the foreside face of the plug and three side faces among four side faces between the plug and the foreside face, and is absorbed by the absorber at the remaining side face, thereby making a complicated shielding structure unnecessary for the PIU.

Also, in the electronic device according to the present invention, a flexible member may be used for the foreside face, a winding mechanism having a winding roll which winds the flexible member and driving means which drive the winding roll in a winding direction may be provided on an upper side face among the three side faces, and guide portions guiding the foreside face may be provided on right and left side faces among the three side faces.

Namely, since the foreside face using a flexible member such as a film can be wound by a guide of a guide portion by driving a winding roll with driving means, the insertion and extraction of the PIU can be easily performed by moving up and down the foreside face by the winding roll.

Also, in the electronic device according to the present invention, the winding roll may have a stopper for stopping the foreside face at a desired position of the guide portion.

Namely, a stopper can stop the foreside face wound by the winding roll at a desired position of the guide portion.

Also, the electronic device according to the present invention may further comprise a support plate with a latching portion, and latched portions latched by the latching portion are provided on the three side faces.

Namely, latched portions provided on the above-mentioned three side faces are latched to a latching portion on a support plate provided for the electronic device, and the above-mentioned cover can be easily attached to the electronic device and can be removed therefrom.

Also, in the electronic device according to the present invention, a hinge may be provided to pivotably fit the upper side face among the three side faces to a front of the cabinet.

Namely, since the cover can be pivoted through the hinge with respect to the electronic device, the insertion and extraction of the PIU can also be easily performed in this case.

Also, the electronic device according to the present invention may use ferrite molded in a shape which enables the absorber to pass the cable as the absorber.

Namely, the absorber provided on the cable support for passing through the cable connected to the PIU toward the outside is molded by ferrite, thereby enabling the electromagnetic wave having leaked to be efficiently absorbed.

Also, in the electronic device according to the present invention, it is preferable that the foreside face comprises translucent or transparent.

Namely, the state of the PIU of the electronic device can be visually recognized easily from the outside through the foreside face translucent or transparent.

As described above, according to the electronic device of the present invention, the electromagnetic wave having leaked from the plug of the PIU is reflected by the reflector in various directions and then absorbed by the absorber, thereby yielding an effect that the electromagnetic wave is efficiently absorbed and a bad influence to other PIUs, an outside human body, or the like can be excluded.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a perspective view showing an embodiment (1) of an electronic device according to the present invention;

FIGS. 2A and 2B are diagrams for illustrating an operation of an embodiment (1) according to the present invention, and specifically for illustrating a state where the reflection of electromagnetic wave is repeated;

FIGS. 3A and 3B are diagrams showing an electric field analysis on electromagnetic wave having leaked from a cabinet of a simplified model; specifically FIG. 3A is a sectional side view showing a state where electromagnetic wave leaks from a slit of a cabinet front to a foreside face of a reflector, and FIG. 3B is a sectional side view showing a state where electromagnetic wave is reflected from a foreside face of a reflector to a cabinet side;

FIGS. 4A and 4B are perspective views (No. 1) showing an embodiment (2) of an electronic device according to the present invention;

FIG. 5 is a perspective view (No. 2) showing an embodiment (2) of an electronic device according to the present invention;

FIG. 6 is a schematic side view showing a state where a foreside face is drawn out of a guide rail end in an embodiment (2) of the present invention;

FIG. 7 is a schematic side view showing a relationship between a foreside face and a cable support in an embodiment (2) of the present invention;

FIGS. 8A-8D are perspective views of an embodiment (3) of an electronic device according to the present invention; specifically FIG. 8A shows a state where a reflector is attached to a cabinet, and FIG. 8B shows a reflector;

FIG. 9 is a perspective view showing an embodiment (4) of an electronic device according to the present invention, which illustrates a state where a reflector is closed;

FIG. 10 is a perspective view showing an embodiment (4) of an electronic device according to the present invention, which illustrates a state where a reflector is opened; and

FIGS. 11A-11C are perspective views showing a prior art electronic device disassembled.

### DESCRIPTION OF THE EMBODIMENTS

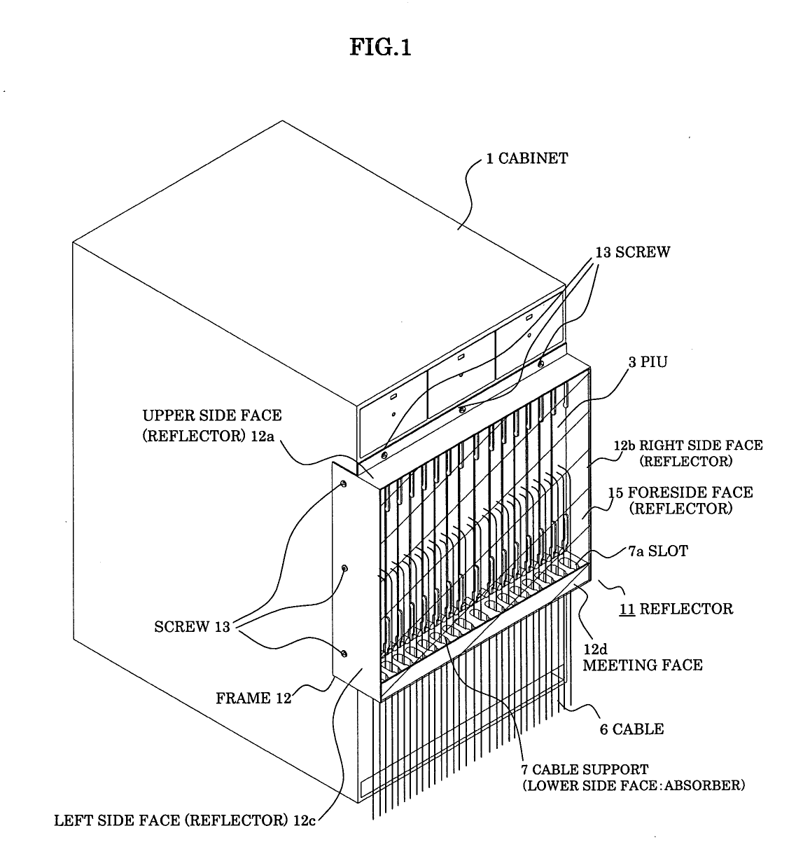

### Embodiment (1): FIGS. 1, 2A, 2B, 3A and 3B

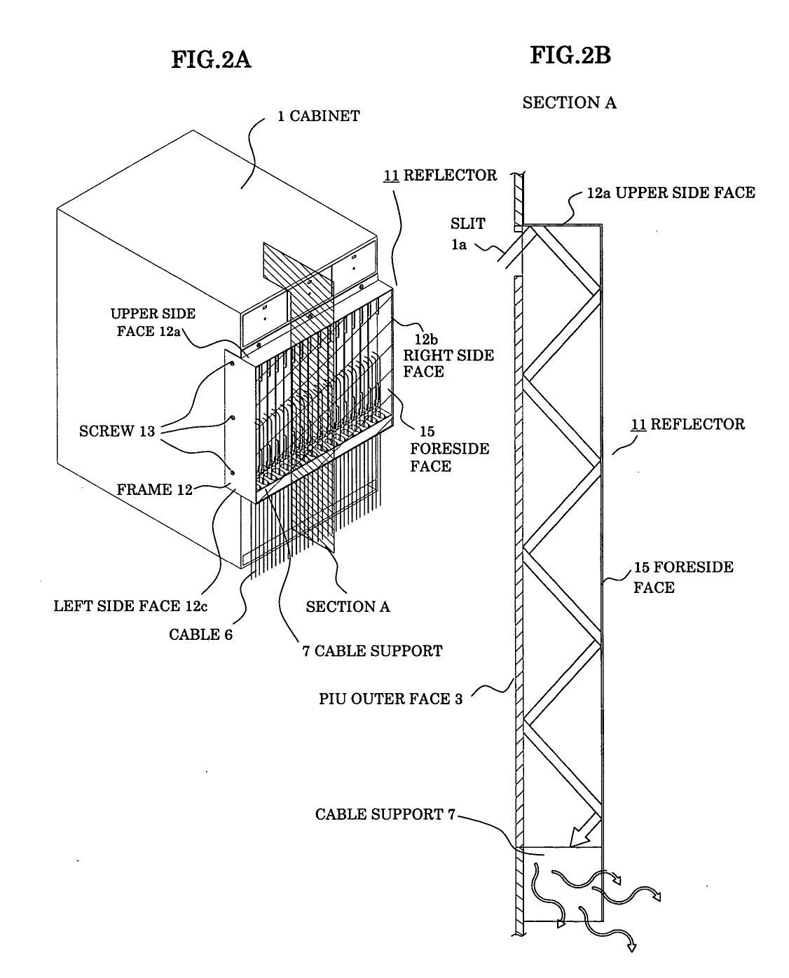

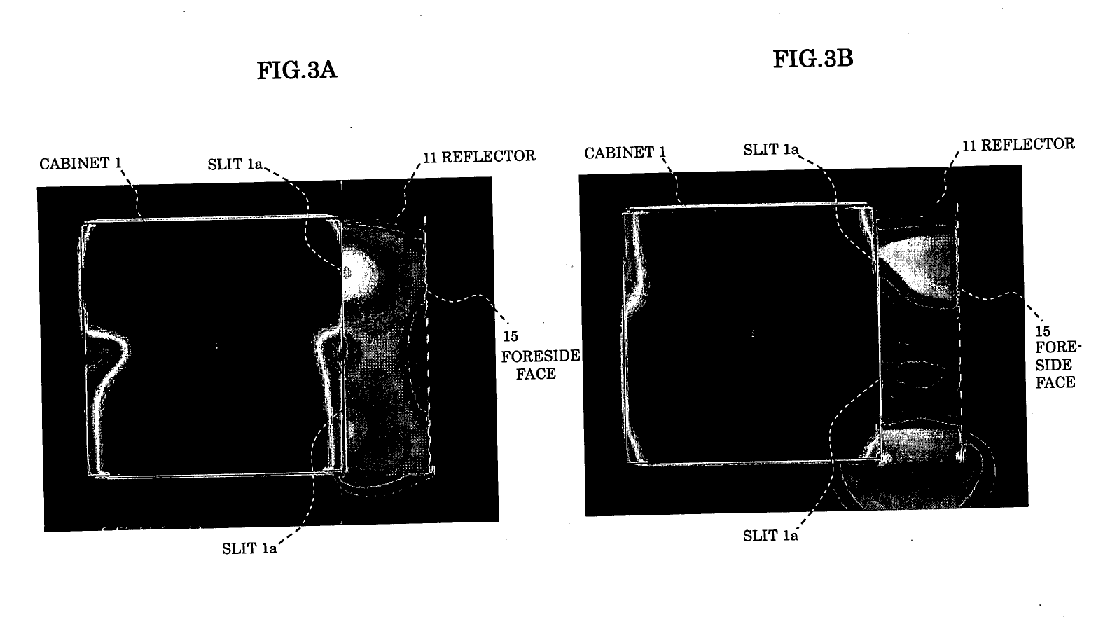

FIG. 1 is a perspective view of an embodiment (1) of an electronic device according to the present invention. FIGS. 2A and 2B show diagrams for illustrating an operation of the embodiment (1). FIG. 2A shows the same perspective view as FIG. 1. FIG. 2B is a diagram of a section A in FIG. 2A, showing a state where the reflection of electromagnetic wave is repeated. FIGS. 3A and 3B are diagrams showing an electric field analysis on the electromagnetic wave having leaked from a cabinet of a simplified model. FIG. 3A is a sectional side view showing a state where the electromagnetic wave leaks from a slit of a cabinet front face to a foreside face of a reflector, and FIG. 3B is a sectional side view showing a state where the electromagnetic wave is reflected from the foreside face of the reflector to the cabinet side.

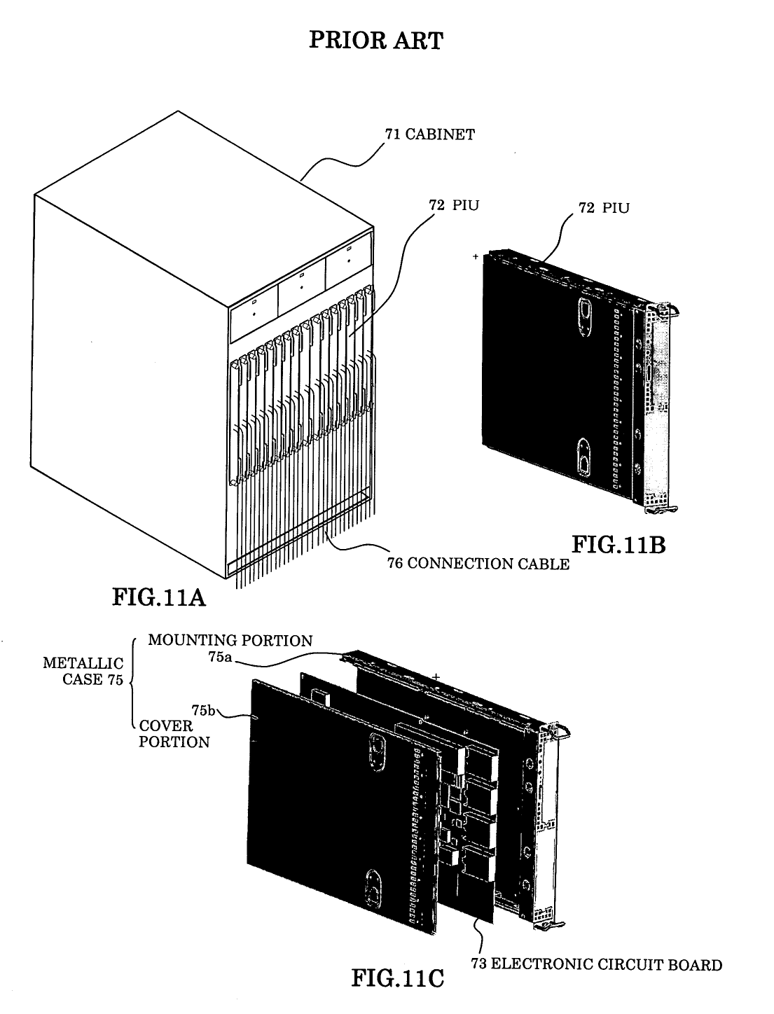

Firstly, in FIGS. 1, 2A and 2B, the electronic device of a sub-rack structure has a metallic cabinet 1 of a nearly rectangular parallelepiped. Each slot formed toward the front face of the cabinet 1 mounts therein a PIU 3. As shown in FIGS. 11A-11C, a board on which an electronic circuit is mounted is covered with a metallic case in each PIU 3, electromagnetic shielding is provided to the clearance with a gasket or the like, and a cable 6 is connected to the metallic case to be taken out of an aperture (not shown).

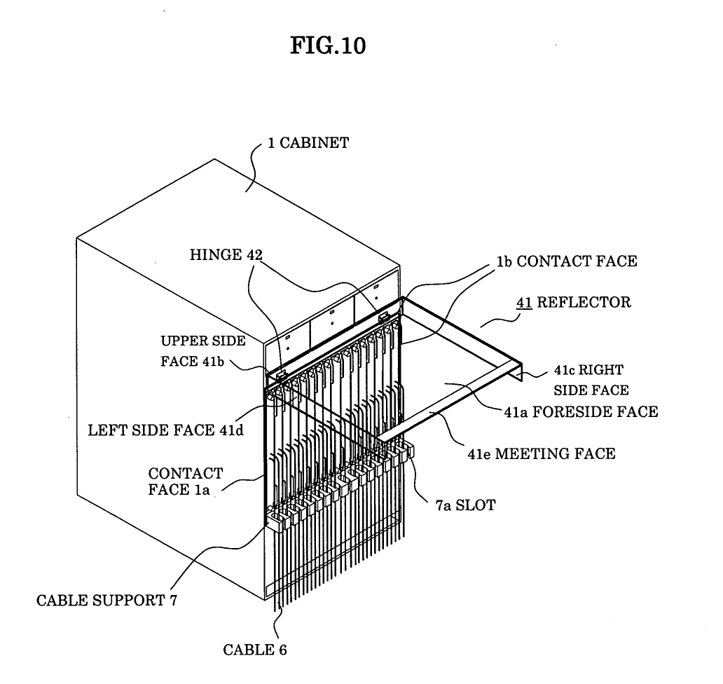

A cable support 7 made of ferrite is attached to a lower side of the front of the cabinet 1 as an absorber which absorbs the energy of the electromagnetic wave. Numerous slots 7a (see also FIG. 10) for passing the cables are formed in the cable support 7. It is to be noted that ferrite may be fixated on the top surface of the cable support 7.

On the other hand, a reflector 11 has a cover-like shape composed of a metallic frame 12 which reflects the electromagnetic wave and a foreside face 15. The frame 12 is composed of an upper side face 12a whose section is L-shaped, right and left side faces 12b and 12c, and a meeting face 12d which meets the cable support 7. The upper side face 12a, right and left side faces 12b and 12c are fixed to the cabinet 1 with screws 13 respectively.

A translucent or transparent electromagnetic wave reflection material which reflects the electromagnetic wave is coated on the foreside face 15, so that the front face of the cabinet 1, i.e. the plug of the PIU 3 can be visibly recognized.

In such an arrangement, as shown in FIGS. 2A and 2B, the electromagnetic wave having leaked from the front of the cabinet 1, i.e. a slit 1a of the plug of the PIU 3 is entered into the reflector 11, and is reflected at the foreside face 15, the upper side face 12a, or the right and the left side faces 12b and 12c. The electromagnetic wave having reflected repeats its reflection among an outer face of the PIU 3, the foreside face 15, the upper side face 12a, and the right and the left side faces 12b and 12c, and is finally absorbed by ferrite of the cable support 7 to be converted into thermal energy.

Accordingly, since the electromagnetic wave having leaked from the front of the cabinet 1 can be efficiently suppressed in the embodiment (1), a complicated shield structure to be secured for an individual PIU 3 can be eliminated, and an economical burden due to difficulty of sheet-metal working of a metallic case is reduced.

Also, since the cable support 7 made of ferrite is attached to the cabinet 1 in the embodiment (1), the weight of the reflector 11 can be reduced.

An electric field analysis which the inventors have performed on the electromagnetic wave having leaked from the cabinet by using a simplified model will now be described referring to FIGS. 3A and 3B.

FIG. 3A is a sectional side view showing a state where the electromagnetic wave leaks from the slit 1a of the front of the cabinet 1 to the foreside face 15 of the reflector 11. A wave source S is placed inside the cabinet 1, and a state where the electromagnetic wave leaks from the slit 1a of the front of the cabinet 1 to the foreside face 15 of the reflector 11 with an electric field reception angle being varied is shown. The state is recognized where the electromagnetic wave from the slit 1a of the cabinet 1 spreads to the foreside face 15 like an undulation on a water surface to be attenuated.

FIG. 3B is a sectional side view showing a state where the electromagnetic wave is reflected from the foreside face 15 of the reflector 11 to the side of the cabinet 1. In the same way as FIG. 3A, a state where the electromagnetic wave reflects from the foreside face 15 to the cabinet 1 side with the electric field reception angle being varied is shown.

Thus, the electromagnetic wave is efficiently reflected by the reflector and is efficiently absorbed by the absorber, so that the electromagnetic wave leakage from the plug of the PIU can be suppressed.

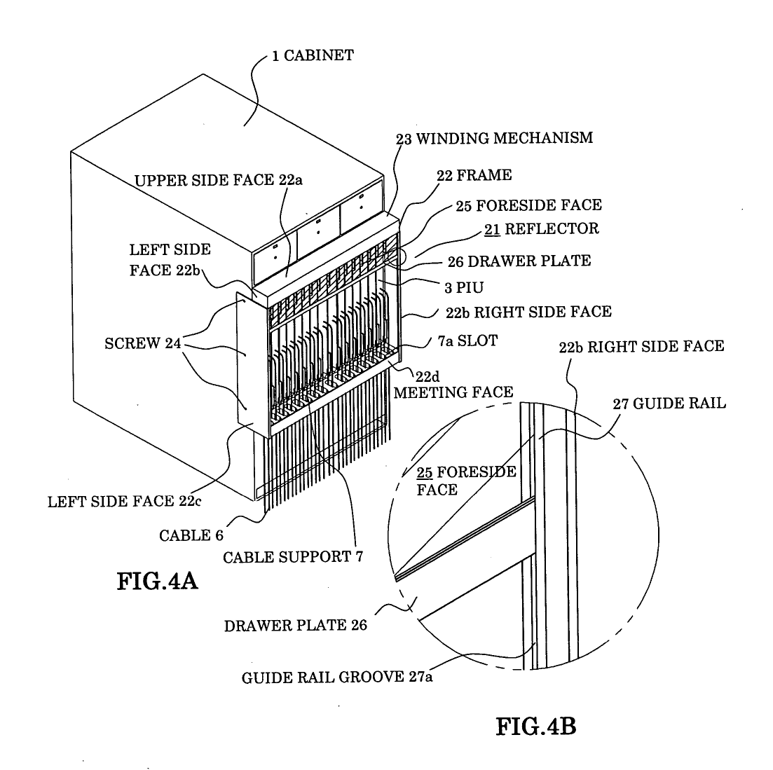

### Embodiment (2): FIGS. 4A, 4B, and 5-7

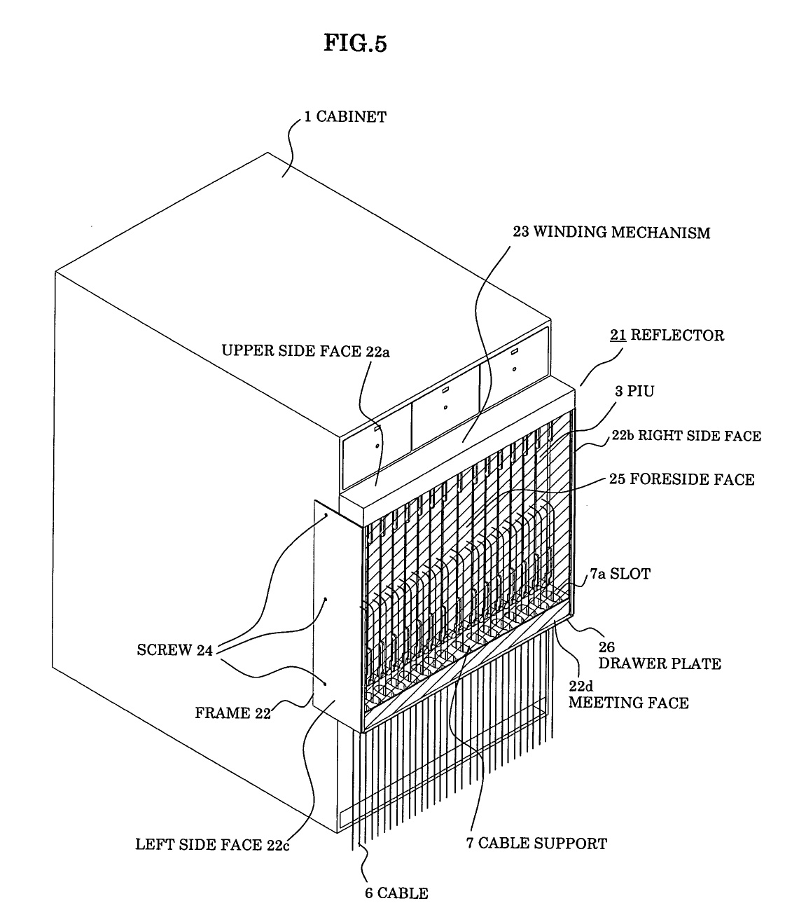

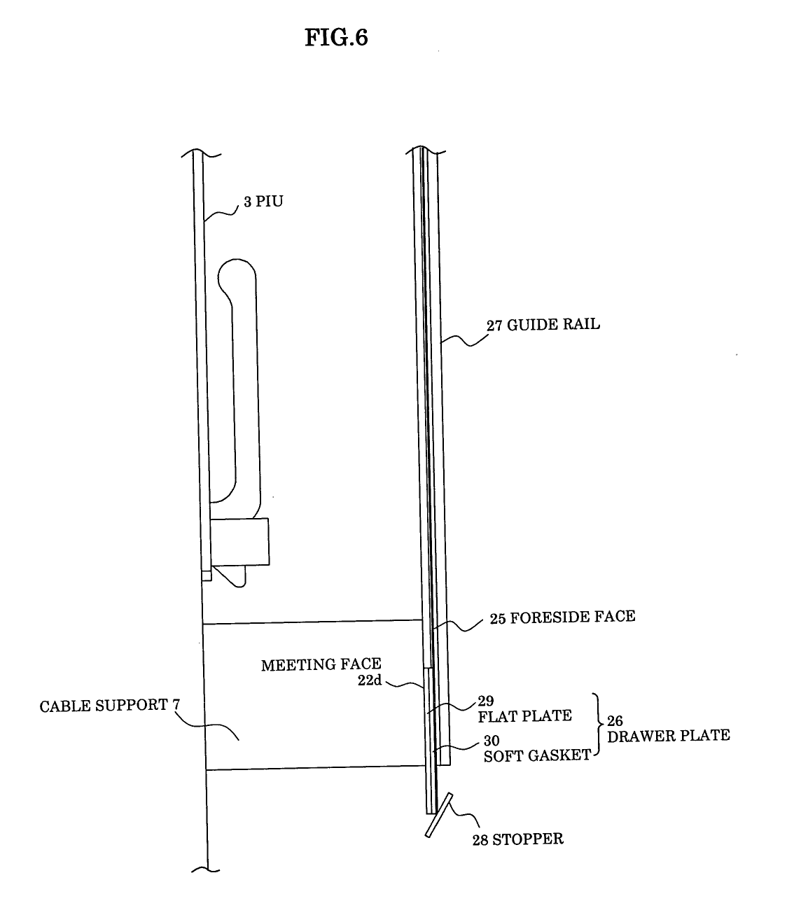

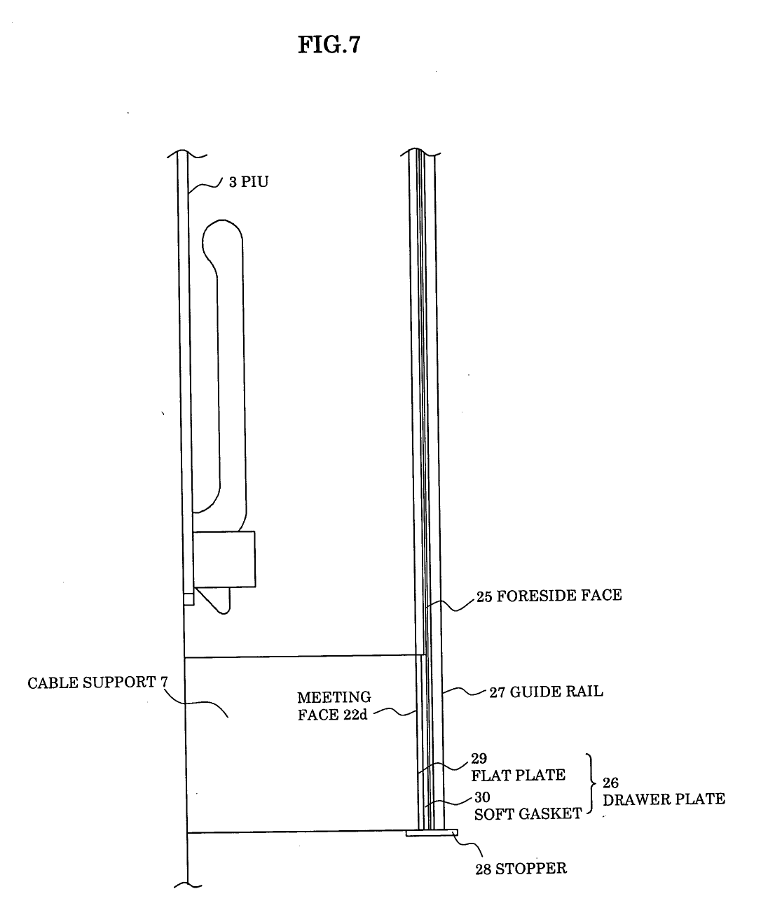

FIGS. 4A and 4B show perspective views of an embodiment (2) of the electronic device according to the present invention. FIG. 4A shows a state where the foreside face 15 is made of a flexible member translucent or transparent and is drawn up. FIG. 4B is a magnified view of the essential part. FIG. 5 shows a perspective view of a state where the foreside face 15 is completely drawn down in the embodiment (2). FIGS. 6 and 7 show a state where a winding roll of the foreside face 15 is drawn out. It is to be noted that the cabinet 1, the PIU 3 and the cable support 7 in FIGS. 4A, 4B and FIG. 5 are the same as those in the embodiment (1).

A reflector 21 is composed of a metallic frame 22, a foreside face 25 and a winding mechanism 23. The frame 22 is composed of an upper side face 22a whose section is L-shaped, right and left side faces 22b and 22c and a meeting face 22d in the same way as the embodiment (1). The right and left side faces 22b and 22c are fixed to the cabinet 1 with screws 24.

In the embodiment (2), the winding mechanism 23 is provided on the upper side face 22a of the frame 22. The mechanism 23 has a winding roll (not shown) which winds the foreside face 25 and a coil spring (not shown) as drive means which drives the winding roll in the winding direction. When the foreside face 25 is drawn down, the coil spring is twisted and transformed.

Also, guide rails 27 are provided in the right and left side faces 22b and 22c of the frame 22 as shown in FIG. 4B. The foreside face 25 is made of a translucent or transparent film and a drawer plate 26 is fixed to the tip of the foreside face 25. Accordingly, the ends of the drawer plate 26 of the foreside face 25 are fitted to grooves 27a of the guide rails 27. Also, a T-shaped stopper 28 for drawing down the drawer plate 26 to the lower end of the guide rails 27 to be stopped is attached to the drawer plate 26.

When the drawer plate 26 of the foreside face 25 is drawn down along the guide rails 27 in the embodiment (2), the foreside face 25 is drawn out of the winding roll. After being drawn down lower than the lower end of the guide rails 27, as shown in FIG. 6, the drawn plate 26 is latched to the lower end of the guide rails 27 to close the foreside face 25 as shown in FIG. 7. When the electromagnetic wave having leaked from the front of the cabinet 1 is entered into the reflector 21 with the foreside face 25 being closed, the electromagnetic wave reflects from the foreside face 25, the upper side face 22a, the right side face 22b or the left side face 22c. The reflected electromagnetic wave repeats the reflection among the outer face of the PIU 3, the foreside face 25, the upper side face 22a, the right side face 22b and/or the left side face 22c as shown in FIG. 2B, and is finally absorbed by the ferrite of the cable support 7 to be converted into the thermal energy.

On the other hand, when the drawer plate 26 of the foreside face 25 is drawn out, the stopper 28 is fitted into the grooves 27a of the guide rails 27 in parallel with the foreside face 25, and the foreside face 25 is drawn up by the coil spring within the winding mechanism 23, the winding roll winds the foreside face 25 to be housed. Accordingly, the PIU 3 can be directly inserted and extracted into/from the cabinet 1.

Thus, in the embodiment (2), the winding mechanism 23 is provided so as to be able to wind up the foreside face 25. Therefore, accesses to the front of the cabinet 1 can be easily performed in addition to the effect of the embodiment (1).

Also, the guide rails 27 are provided in the right and left side faces 22b and 22c of the frame 22 to guide the foreside face 25 in the embodiment (2). Therefore, no distortion or flexure occurs in the foreside face 25 when the foreside face 25 is drawn down or drawn up. Furthermore, since the foreside face 25 can be wound and housed by the winding mechanism 23, the electronic device can be compact-sized.

It is to be noted that the foreside face 25 can not be fixed at an arbitrary drawing position of the guide rails 27 in the above-mentioned embodiment (2). Therefore, a stopper may be provided which can temporarily hold the foreside face 25 wound by the winding roll of the winding mechanism 23, and which can wind up the foreside face if the drawer plate 26 of the foreside face 25 having stopped at the drawing position is drawn again.

Thus, the foreside face 25 can be stopped at an arbitrary drawing position by the stopper. Therefore, the accessibility to the front of the cabinet 1 is increased compared with the case where the foreside face 25 is drawn down to the lower end.

It is to be noted that the drawer plate 26 is composed of a ferrite flat plate 29 attached to the meeting face 22d of the foreside face 25 and a soft gasket 30 attached to the flat plate 29 as shown in FIGS. 6 and 7. The soft gasket 30 pushes the flat plate 29 in the direction of the meeting face 22d of the cable support 7 by its elastic repulsion. Thus, the clearance between the cable support 7 and the flat plate 29 is blocked.

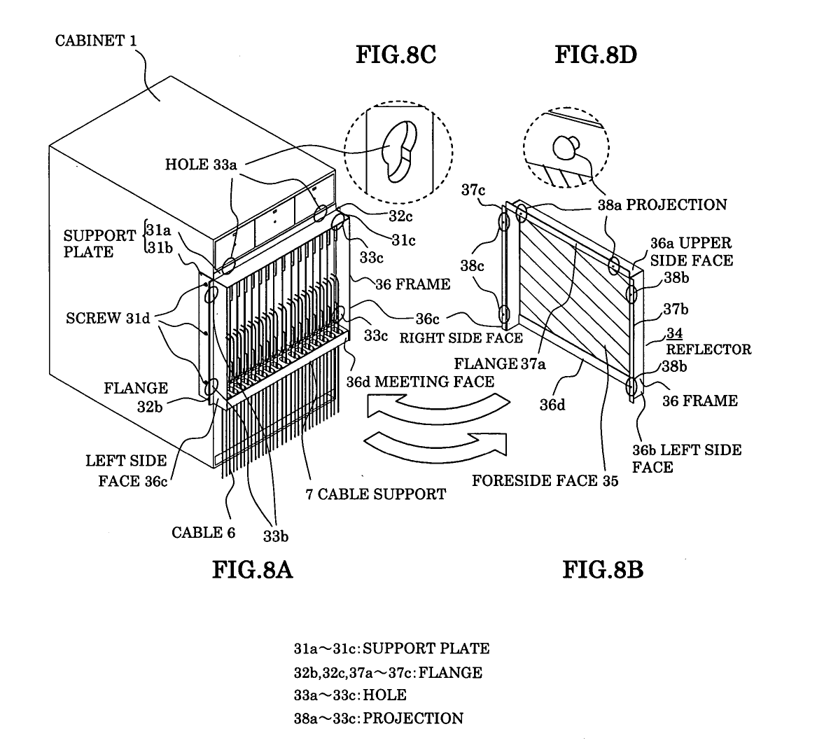

### Embodiment (3): FIGS. 8A-8D

FIGS. 8A-8D show perspective views of an embodiment (3) of the electronic device according to the present invention. FIG. 8A shows the entire electronic device to which a reflector 34 is attached. FIG. 8B shows the reflector 34 itself. Also, the FIGS. 8C and 8D show magnified views of a latching portion and a latched portion when the reflector 34 is attached to the cabinet 1 of the electronic device.

Firstly, in FIG. 8A, a support plate 31a is fixed to the front of the cabinet 1, a pair of support plates 31b and 31c are fixed to the sides thereof with screws 31d, and flanges 32b and 32c are respectively provided to the both support plates 31b and 31c. Holes 33a, 33b and 33c forming the latching portion shown in FIG. 8C are provided on the support plate 31a, and the flanges 32b and 32c.

On the other hand, the reflector 34 shown in FIG. 8B is composed of a foreside face 35 and a frame 36. The frame 36 is composed of an upper side face 36a, and right and left side faces 36b and 36c, which have flanges 37a-37c respectively. Projections 38a-38c, also forming latched portions whose magnified view is shown in FIG. 8D are provided on the flanges 37a-37c respectively.

The projection 38a of the reflector 34 is engaged or latched in the hole 33a of the support plate 31a, the projection 38b is engaged in the hole 33b of the flange 32b of the support plate 31b, and the projection 38c is engaged in the hole 33c of the flange 32c of the support plate 31c, whereby, as shown in FIG. 8A, the reflector 34 can be attached so as to cover the front of the cabinet 1, i.e. the plug of the PIU 3. Namely, since the meeting face 36d of the reflector 34 meets the cable support 7 in the same way as the above-mentioned embodiments, the electromagnetic wave having leaked from the plug of the PIU 3 can be confined to the reflector 34, and can be absorbed by the absorber of ferrite or the like on the cable support 7.

Thus, from the relationship between the holes 33a-33c and the projections 38a-38c, the reflector 34 attached to the cabinet 1 can be detached therefrom while being lifted, and can be easily attached or detached to/from the cabinet 1. Therefore, accesses to the front of the cabinet 1 can be easily performed.

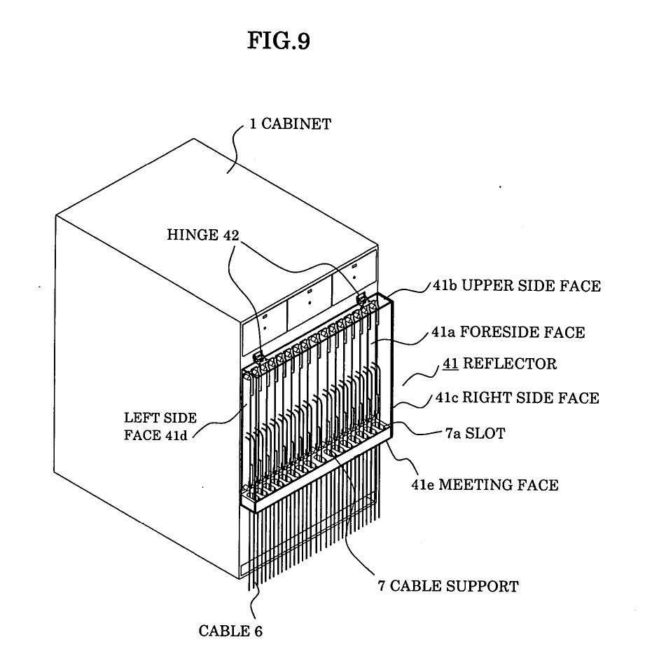

### Embodiment (4): FIGS. 9 and 10

FIGS. 9 and 10 show perspective views of the embodiment (4) of the electronic device according to the present invention. FIG. 9 shows the state where a reflector 41 is closed, and FIG. 10 shows the state where the reflector 41 is open.

Namely, the reflector 41 made of acrylic is used, and a torque hinge 42 is provided on the upper side face, whereby the state where the reflector 41 is closed shown in FIG. 9 can be changed to the state where the reflector 41 is opened shown in FIG. 10, that is a characteristic of this embodiment.

Accordingly, if the reflector 41 is turned upward to be opened, the PIU 3 can be easily inserted and extracted into/from the cabinet 1.

Also, since being attached to the front of the cabinet 1 through the torque hinge 42, the reflector 41 can be positioned at an arbitrary angle, and accesses to the front of the cabinet 1 can be easily performed. Furthermore, since the burden in aspect of weight is reduced in the torque hinge 42 by using the acrylic board for the reflector 41, the opening/closing operation of the reflector 41 can be performed lightly and visibility of the front of the cabinet 1 becomes superior.

It is to be noted that in the above-mentioned embodiments the foreside face has only to reflect the electromagnetic wave, and the conductivity of the foreside face and the connectivity to the earth are unquestioned.

Also, while the material of the absorber provided on the cable support is ferrite in the above-mentioned embodiments, it is not limited to the ferrite but any material can be used so long as it can absorb the energy of the electromagnetic wave.

Furthermore, in the above-embodiments, the shape of the slot provided to the cable support can be changed. If a cable support whose slot for passing the cable is molded a little larger is used, a heat radiation effect can be increased. Also, when a signal cable and a power cable from another device are connected to the PIU, the electromagnetic wave emitted outside through the signal cable and the power cable can be simultaneously suppressed by using a cable support molded so as to intimately contact with the signal cable and the power cable.

Also, while the cable support is attached to the cabinet side in the above-mentioned embodiment, the cable support may be attached to the reflector side instead of the cabinet side. In this case, the reflector is shaped like a box.

1. An electronic device comprising:
a reflector provided so as to cover a plug of a sub-rack into which a plug-in unit is plugged, and reflecting an electromagnetic wave which leaks from the plug; and
a cable support supporting a cable connected to the plug-in unit and taken out of the plug, and forming an absorber which absorbs the electromagnetic wave reflected by the reflector.

2. The electronic device as claimed in claim 1, wherein the reflector has a cover-like shape formed by a foreside face facing to the plug and three side faces between the plug and the foreside face, and the absorber forms a remaining side face.

3. The electronic device as claimed in claim 2, wherein a flexible member is used for the foreside face, a winding mechanism having a winding roll which winds the flexible member and driving means which drive the winding roll in a winding direction is provided on an upper side face among the three side faces, and guide portions guiding the foreside face are provided on right and left side faces among the three side faces.

4. The electronic device as claimed in claim 3, wherein the winding roll has a stopper for stopping the foreside face at a desired position of the guide portion.

5. The electronic device as claimed in claim 2, further comprising a support plate with a latching portion, and latched portions latched by the latching portion are provided on the three side faces.

6. The electronic device as claimed in claim 2, wherein a hinge is provided to pivotably fit the upper side face among the three side faces to a front of the cabinet.

7. The electronic device as claimed in claim 1, wherein the absorber comprises ferrite molded in a shape which enables the absorber to pass the cable.

8. The electronic device as claimed in claim 1, wherein the foreside face comprises translucent or transparent.

9. The electronic device as claimed in claim 2, wherein the absorber comprises ferrite molded in a shape which enables the absorber to pass the cable.

10. The electronic device as claimed in claim 3, wherein the absorber comprises ferrite molded in a shape which enables the absorber to pass the cable.

11. The electronic device as claimed in claim 4, wherein the absorber comprises ferrite molded in a shape which enables the absorber to pass the cable.

12. The electronic device as claimed in claim 5, wherein the absorber comprises ferrite molded in a shape which enables the absorber to pass the cable.

13. The electronic device as claimed in claim 6, wherein the absorber comprises ferrite molded in a shape which enables the absorber to pass the cable.

14. The electronic device as claimed in claim 2, wherein the foreside face comprises translucent or transparent.

15. The electronic device as claimed in claim 3, wherein the foreside face comprises translucent or transparent.

16. The electronic device as claimed in claim 4, wherein the foreside face comprises translucent or transparent.

17. The electronic device as claimed in claim 5, wherein the foreside face comprises translucent or transparent.

18. The electronic device as claimed in claim 6, wherein the foreside face comprises translucent or transparent.

19. The electronic device as claimed in claim 7, wherein the foreside face comprises translucent or transparent.
